(19) United States
(12) Patent Application Publication
(10) Pub. No.: US 2025/0104346 A1
(43) Pub. Date: Mar. 27, 2025

(54) SHARED EVENT RECORDING AND RENDERING

(71) Applicant: Apple Inc., Cupertino, CA (US)

(72) Inventors: Daniel Kurz, Hilo, HI (US); Michael J. Rockwell, Palo Alto, CA (US)

(21) Appl. No.: 18/807,283

(22) Filed: Aug. 16, 2024

Related U.S. Application Data
(60) Provisional application No. 63/607,200, filed on Dec. 7, 2023.
(60) Provisional application No. 63/540,422, filed on Sep. 26, 2023.

(51) Int. Cl. G06T 17/00

(52) U.S. Cl. CPC G06T 17/00

(57) ABSTRACT

Various implementations record a shared event by generating a temporal-based three-dimensional (3D) representation for use in providing/rendering views of the recorded event. For example, a method may include determining that a second device is currently at an event at a physical environment. The method may further include providing a notification to the second device for an option to authorize use of sensor data based on determining that the second device is currently at the event. The method may further include receiving authorization to use the sensor data. The method may further include obtaining the sensor data from the second device in accordance with the authorization. The method may further include generating a temporal-based 3D representation of the event based on the sensor data obtained from the second device and additional sensor data obtained from one or more other devices at the event.

### CROSS-REFERENCE TO RELATED APPLICATIONS

This application claims the benefit of U.S. Provisional Application Ser. No. 63/607,200 filed Dec. 7, 2023, and U.S. Provisional Application Ser. No. 63/540,422 filed Sep. 26, 2023, each of which is incorporated by reference herein in its entirety.

### TECHNICAL FIELD

The present disclosure generally relates to electronic devices that provide views of multi-user environments, including views that include a temporal-based 3D representation of a shared experience or event.

### BACKGROUND

It may be desirable to generate and display a temporal-based three-dimensional (3D) representation of a shared experience or event (e.g., multiple users at a concert), such as a 3D model, while a user is using a device, such as a head mounted device (HMD). However, existing systems may not utilize data that is potentially available from other sources to generate such a representation.

### SUMMARY

Various implementations disclosed herein include devices, systems, and methods that provide a depiction of a shared experience or event within a multi-user 3D environment such as an extended reality (XR) environment. An exemplary process records a shared (e.g., multi-user) event (e.g., a concert, a birthday party, etc.) by generating a temporal-based 3D representation for use in providing/rendering views of the recorded event from multiple perspectives. For example, for a sixty-second recorded event, the temporal-based 3D representation may be used to provide different perspective views, with a first view provided for a first time point during the event, a second view provided for the next time point during the event, etc. A user at the event can optionally participate in the shared event recording process by contributing the user device's sensor data (e.g., RGB images/video, depth data, position information, etc.) to a recording of the shared event. Based on agreeing to participate (e.g., authorizing use of the user's device captured data) and/or contributing to the shared event recording, the user/device may be granted access to the generated temporal-based 3D representation of the event so that the user can re-live the event from multiple different perspectives.

Additionally, various implementations disclosed herein include devices, systems, and methods that render views corresponding to multiple instances of time during a time period of a recorded event (e.g., 60 seconds of different views are provided that correspond to a 60 second recorded event, with a first view provided for a first time point during the event, a second view provided for the next time point during the event, etc.). In some implementations, a unique viewing perspective of the recorded event is generated based on a previously recorded viewpoint of the event, and that unique viewing perspective need not correspond to a location from which the event was previously recorded. In some implementations, the viewpoint may be specified by the renderer (e.g., changing based on current renderer HMD poses).

In some implementations, the views may be generated using a volume rendering model such as a neural rendering model (e.g., a Neural Radiance Field (NeRF) model) that is trained using sensor data captured during the event (e.g., image data) from multiple locations/devices. For example, for each of a plurality of rendering timepoints (e.g., rendering frames), the rendering device may “query” the model by specifying input (e.g., a time point and a viewpoint) to the model and receive output from the model. For example, the output of the model may include information on the visual appearance of queried points of a view of the event at the time and from the viewpoint. In some instances, the queried points may lie on rays corresponding to pixels based on the view of the event at the queried time and viewpoint from the specified input.

In an exemplary implementation, the model additionally returns an “expiration” value (ε) as part of the output (e.g., an expiration time for each ray). The renderer uses this information from the expiration value (ε) to limit its queries to the volume rendering model. For example, if the viewpoint has not changed (within a threshold) from one time to the next time, the renderer need not query the model for certain new values (e.g., rays that have not expired). This may reduce the number of queries when rendering a dynamic scene that has many static parts, from a fixed viewpoint. The renderer only queries the volume rendering model at positions where something changed in the scene and it avoids repeatedly querying the volume rendering model about parts of the scene that did not change, which will significantly reduce the number of queries needed, reduce computational complexity, and may enable rendering at higher frame rates, at higher resolutions, or with less power.

In some implementations, the expiration values determined by a volume rendering model may be based on dissimilarity thresholds regarding colors/densities-transparency differences, e.g., the standard deviation of values, or the difference between the min and max values. Additionally, or alternatively, in some implementations, expiration values determined by a volume rendering model may be based on ray differences, e.g., angle between two rays, ray origin differences, etc. Additionally, or alternatively, in some implementations, expiration values determined by a volume rendering model may be based on a per-frame expiration budget (similar number of rays expiring at the same time), and/or a prioritization based on visible scene changes.

In some implementations, the shared event recording and rendering processes described herein may be utilized for live streaming, sampling rate control, and some other possible implementation details. For example, for live streaming, the shared event recording and rendering processes requires knowledge of the future (e.g., how long does this part of the scene remain unchanged), so that the image data is well-suited for offline batch processing of recorded content. The shared event recording and rendering processes can also be used for live streaming of events using NeRFs plus expiration values (e.g., one NeRF per frame, or one NeRF per second that encodes 90 frames) if a small latency is tolerated for the final rendering. For example, if the live streaming content is delayed by one second, shared event recording and rendering algorithm is able to look into the future for one second, then the expiration value can be anything less or equal to one second, and it will be one second for static parts of the scene. Having to sample those rays only once per second based on a query instead of 90 times per second presents a substantial efficiency improvement over other NeRF protocols.

Additionally, for example, for sampling rate control, the shared event recording and rendering processes may utilize the ray expiration dates, and determine that such expiration values such that there is a number of all rays expiring at any given timestamp is capped to a certain value (e.g., per-frame expiration budget). Any rays that should also expire at the same timestamp but would exceed the per-frame expiration budget, may be assigned a slightly later expiration date, e.g., one timestamp later. Sorting dynamic scene changes by their difference may be used to prioritize setting the expiration date of strong scene changes correctly, while the expiration date of less severe scene changes can be slightly delayed. In some implementations, the determination of expiration dates attempts achieve a similar number of expiring rays at every given frame therefore resulting in a more constant compute load over time. This can again be achieved by prioritizing the temporal accuracy of the expiration date of highly visible scene changes while deprioritizing less visible scene changes which can be assigned a slightly later expiration date resulting in them being updated by the renderer slightly later then they actually occurred.

In general, one innovative aspect of the subject matter described in this specification can be embodied in methods, at a first device having one or more processors, that include the actions of determining that a second device is currently at an event at a physical environment based on one or more event criterion, providing a notification to the second device based on determining that the second device is currently at the event, the notification providing an option to authorize use of sensor data obtained by the second device during the event to generate a temporal-based three-dimensional (3D) representation of the event, receiving authorization to use the sensor data to generate the temporal-based 3D representation of the event, wherein the authorization is based on user input received at the second device in response to the notification, obtaining the sensor data from the second device in accordance with the authorization, and generating the temporal-based 3D representation of the event based on the sensor data obtained from the second device and additional sensor data obtained from one or more other devices at the event.

These and other embodiments can each optionally include one or more of the following features.

In some aspects, access to use the temporal-based 3D representation of the event is based on the authorization. In some aspects, users who contributed to the temporal-based 3D representation are provided access to use the temporal-based 3D representation of the event is based on the authorization.

In some aspects, the additional sensor data is obtained from the one or more other devices at the event based on receiving additional authorization from the one or more other devices at the event to use the additional sensor data to generate the temporal-based 3D representation of the event.

In some aspects, the temporal-based 3D representation is a neural rendering model. In some aspects, the neural rendering model is neural radiance field (NeRF) model. In some aspects, the NeRF model is configured to receive input corresponding to a 3D viewpoint and a timepoint during the event. In some aspects, the NeRF model is configured to output a plurality of ray values corresponding to a view of the event from the 3D viewpoint at the timepoint during the event. In some aspects, the NeRF model is configured to output an expiration corresponding to one or more of the ray values.

In some aspects, the expiration is determined based on a dissimilarity threshold corresponding to ray color or ray density. In some aspects, the expiration is determined based on a dissimilarity threshold corresponding to ray position or orientation differences. In some aspects, the expiration is determined based on a per-timepoint expiration budget. In some aspects, the expiration is determined based on a prioritization determined based on determining visible scene changes.

In some aspects, the method further includes the actions of updating a portion of the temporal-based 3D representation of the event by obtaining user-based image content from a user database, and augmenting the portion of the temporal-based 3D representation of the event based on the user-based image content.

In general, one innovative aspect of the subject matter described in this specification can be embodied in methods, at an electronic device having a processor, that include the actions of, for each of a plurality of rendering timepoints, determining a three-dimensional (3D) event viewpoint corresponding to a 3D position in a physical environment of a recorded event, determining an event timepoint corresponding to a time during a time period of the recorded event, inputting the 3D event viewpoint and the event timepoint into a neural rendering model, the neural rendering model trained using sensor data captured during the recorded event by multiple devices, receiving an output from the neural rendering model, the output including (i) a plurality of ray values corresponding to a view of the recorded event from the 3D viewpoint at the timepoint during the recorded event, and (ii) an expiration corresponding to one or more of the ray values, and providing the view of the recorded event based on the received output.

These and other embodiments can each optionally include one or more of the following features.

In some aspects, at least one view for the rendering timepoint reuses rays from a prior view based on the expiration of the rays from the prior view. In some aspects, the method further includes the actions of inputting ray data into the neural rendering model, where the ray data identifies, a first subset of less than all of the rays in the view that the output is to include, or a second subset of less than all of the rays in the view that the output is to exclude. In some aspects, the first subset or second subset is determined based on expiration data corresponding to expiration of one or more rays output by the neural rendering model for a previous rendering timepoint.

In some aspects, the expiration is determined based on a dissimilarity threshold corresponding to ray color. In some aspects, the expiration is determined based on a dissimilarity threshold corresponding to ray density or transparency. In some aspects, the expiration is determined based on a dissimilarity threshold corresponding to ray position or orientation differences. In some aspects, the expiration is determined based on a per-timepoint expiration budget. In some aspects, the expiration is determined based on a prioritization determined based on determining visible scene changes.

In some aspects, updating a portion of the temporal-based 3D representation of the event by obtaining user-based image content from a user database, and augmenting the portion of the temporal-based 3D representation of the event based on the user-based image content.

In some aspects, generating the temporal-based 3D representation of the event based on the sensor data obtained from the second device and the additional sensor data obtained from the one or more other devices at the event includes determining synchronized data based on the sensor data obtained from the second device and the additional sensor data obtained from the one or more other devices based on one or more synchronization algorithms, and generating the temporal-based 3D representation of the event based on the determined synchronized data. In some aspects, the one or more synchronization algorithms are based on a common clock synchronization associated with the second device and the one or more other devices, image content obtained from the second device corresponding to additional image content obtained from the one or more other devices, audio content obtained from the second device corresponding to additional audio content obtained from the one or more other devices, or a combination thereof.

In some aspects, generating the temporal-based 3D representation of the event based on the sensor data obtained from the second device and the additional sensor data obtained from the one or more other devices at the event includes determining refined image data based on the sensor data obtained from the second device and the additional sensor data obtained from the one or more other devices based on one or more transformation algorithms, and generating the temporal-based 3D representation of the event based on the determined refined image data.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example of multiple devices used within a physical environment in accordance with some implementations.

FIG. 2A illustrates exemplary electronic devices operating in the same physical environment with a view for a first device within an extended reality (XR) environment while recording content for a shared event in accordance with some implementations.

FIG. 2B illustrates exemplary electronic devices operating in the same physical environment with a view for a second device that includes a request to opt in to sharing content for a shared event in accordance with some implementations.

FIG. 3 illustrates exemplary electronic devices operating in the same physical environment and recording content for a shared event and an associated location map based on the locations of the electronic devices in accordance with some implementations.

FIG. 4 illustrates an exemplary electronic device operating in a different physical environment than the physical environment of FIGS. 1A-1B, in accordance with some implementations.

FIG. 5A illustrates an exemplary 3D environment generated based on the physical environment of FIG. 4 and a portal displaying portal content within the 3D environment, in accordance with some implementations.

FIG. 5B illustrates an exemplary interaction with the portal content displayed within the portal of FIG. 5A, in accordance with some implementations.

FIG. 6 illustrates an environment for implementing a process for generating a temporal-based 3D representation of a shared event based on sensor data from two or more devices, according to embodiments of the invention.

FIG. 7 is a process flow chart illustrating an exemplary process generating a temporal-based 3D representation of a shared event from a volume rendering model based on expiration values, in accordance with some implementations.

FIG. 8 is a flowchart illustrating a method for generating a temporal-based 3D representation of a shared event based on sensor data from two or more devices, in accordance with some implementations.

FIG. 9 is a flowchart illustrating a method for providing a view of a recorded event based on an output from a neural rendering model, in accordance with some implementations.

FIG. 10 is a block diagram of an electronic device of in accordance with some implementations.

FIG. 11 is a block diagram of a head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

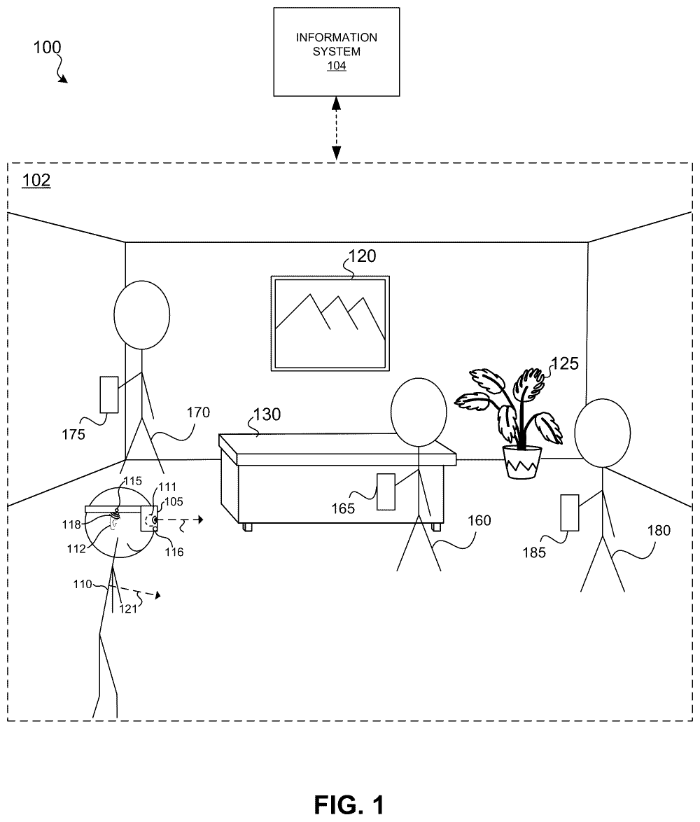

FIG. 1 illustrates an example environment 100 of exemplary electronic devices 105, 165, 175, and 185 operating in a physical environment 102. Additionally, example environment 100 includes an information system 104 in communication with one or more of the electronic devices 105, 165, 175, and 185. In some implementations, electronic devices 105, 165, 175, and 185 may be able to share information with one another or an intermediary device such as the information system 104. Additionally, physical environment 102 includes user 110 wearing device 105, user 160 holding device 165, user 170 holding device 175, and user 180 holding device 185. In some implementations, the devices are configured to present views of an extended reality (XR) environment, which may be based on the physical environment 102, and/or include added content such as virtual elements providing text narrations.

In the example of FIG. 1, the physical environment 102 is a room that includes physical objects such as wall hanging 120, plant 125, and desk 130. Each electronic device 105, 165, 175, and 185 may include one or more cameras, microphones, depth sensors, motion sensors, or other sensors that can be used to capture information about and evaluate the physical environment 102 and the objects within it, as well as information about each user 110, 160, 170, and 180 of the electronic devices 105, 165, 175, and 185, respectively. The information about the physical environment 102 and/or each user 110, 160, 170, and 180 may be used to provide visual and audio content during a recording of a shared event or experience. For example, a shared experience/event session may provide views of a 3D environment that is generated based on camera images and/or depth camera images from one or more electronic devices of the physical environment 102 based on camera images and/or depth camera images captured of the environment. One or more the electronic devices may provide views of a 3D environment that includes representations of the users 110, 160, 170, and 180.

In the example of FIG. 1, the first device 105 includes one or more sensors 116 that capture light-intensity images, depth sensor images, audio data or other information about the user 110 and the physical environment 100. For example, the one or more sensors 116 may capture images of the user's forehead, eyebrows, eyes, eye lids, cheeks, nose, lips, chin, face, head, hands, wrists, arms, shoulders, torso, legs, or other body portion. Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding based on sensor data obtained by a user worn device, such as first device 105. Such a user understanding may be indicative of a user state that is associated with providing user assistance. In some example, a user's appearance or behavior or an understanding of the environment may be used to recognize a need or desire for assistance so that such assistance can be made available to the user. For example, based on determining such a user state, augmentations may be provided to assist the user by enhancing or supplementing the user's abilities, e.g., providing guidance or other information about an environment to disabled/impaired person.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons (e.g., users 160, 170, etc.) are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

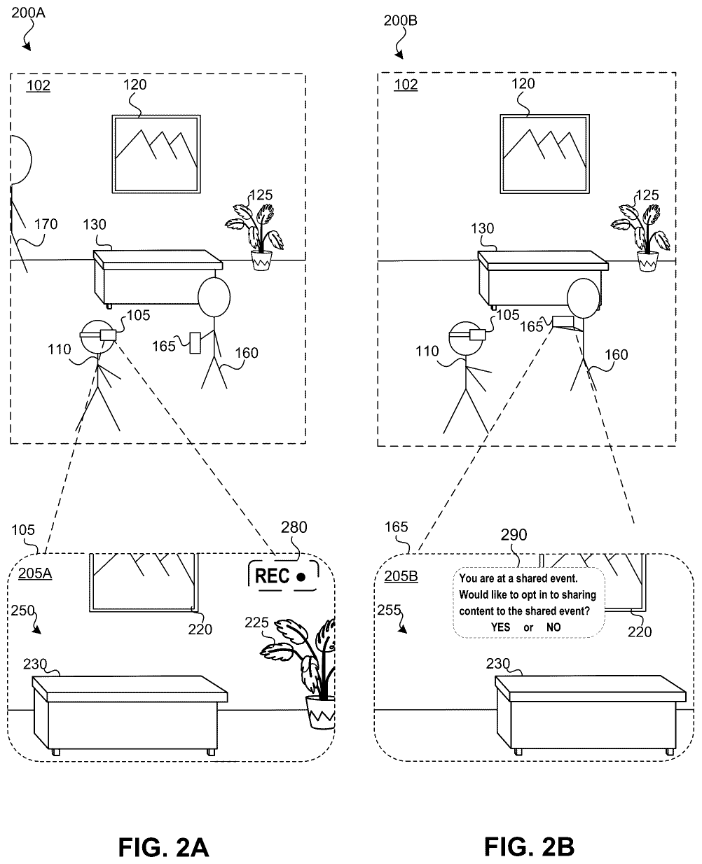

FIG. 2A illustrates exemplary electronic devices operating in the same physical environment with a view for a first device within an extended reality (XR) environment while recording content for a shared event in accordance with some implementations. In particular, FIG. 2A illustrates an exemplary environment 200A of an exemplary view 205A of a physical environment 102 provided by an electronic device 105 during an event (e.g., a party) with user 160 using device 165. The view 205A is of a 3D environment 250 that is based on the physical environment 102. FIGS. 2A and 2B illustrate recording content during an event and determining whether there is consent to share content of the recorded event with other devices. For example, the user 110 views the representation of the other user 160 and a representation of the physical environment 102 of user 110 (e.g., an office of user 110). The view 205A includes representation 225 of plant 125, representation 220 of wall hanging 120, and representation 230 of desk 130. Additionally, FIG. 2A represents a view for user 110 after the user 110 as initiated recording content of the event. For example, as illustrated in FIG. 2A, the user 110 is provided a notification recording symbol 280 as a notification to the user that the device 105 is participating in a live recording of an event/experience.

FIG. 2B illustrates exemplary electronic devices operating in the same physical environment during an event with a view for a device that includes a request to opt in to sharing content for a shared event in accordance with some implementations. In particular, FIG. 2B illustrates an exemplary operating environment 200B of an exemplary view 205B of an electronic device 165 while recording an event (e.g., a party) from his or her perspective, while user 110 using device 105 is recording the same event from his or her perspective. The view 205B is of a 3D environment 255 that is a representation of the physical environment 102 of the device 165. The view 205B includes representation 220 of wall hanging 120 and representation 230 of desk 130. In particular, FIG. 2B illustrates initiating a text transcription of an opt in request (e.g., transcription bubble 290) for requesting permission from user 160 to participate in sharing recorded content for a particular shared event. The request may be initiated by another device recording information about the same event (e.g., device 105), or may be initiated by another source, such as information system 104 (e.g., an external system that determines the devices are recording the same event). Thus, by opting in to sharing content of an event, the user 160 initiates the transfer of recorded content from the event to be shared. Additionally, or alternatively, by providing access to the recorded event, the system may provide access for the user 160 to view a temporal-based volume rendering of the shared event at a later time, as further discussed herein.

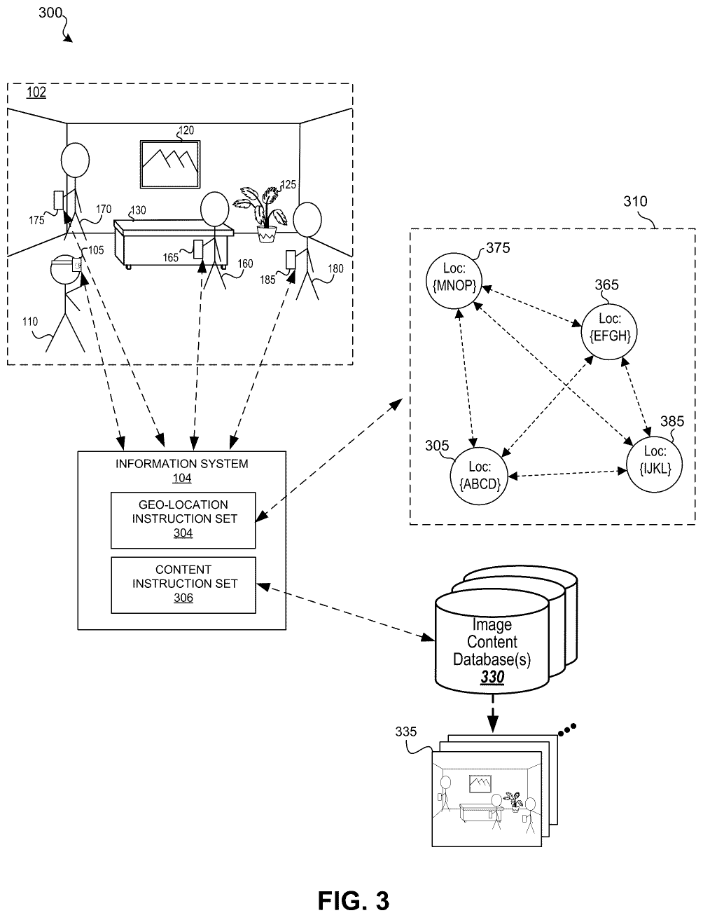

FIG. 3 illustrates exemplary electronic devices operating in the same physical environment and recording content for a shared event and an associated location map of based on the locations of the electronic devices in accordance with some implementations. In particular, FIG. 3 illustrates an exemplary environment 300 of the physical environment 102 of FIG. 1, a generated location network map 310 (e.g., a mesh network map) from a geo-location instruction set 304 based on the determined locations of the devices in physical environment 102, and image content database(s) 330 for collecting the recorded content 335 from the one or more devices. For example, a geo-location network (e.g., mesh network) may be utilized based on the location/position data of multiple devices in a room (e.g., devices 105, 165, 175, 185, etc.), while the identity of each device is kept anonymous (e.g., via anonymization, tokenization, etc.) as the information system 104 records and collect image content from each device.

In an exemplary implementation, the content instruction set 306 of the information system 104 collects the recorded content 335 from the one or more devices and stores the content in the one or more image content database(s) 330. For instance, information system 104 can generate a complete 3D representation of the event based on 2D and/or 3D images captured by devices by rendering views corresponding to multiple instances of time during a time period of a recorded event (e.g., 60 seconds of different views may be provided that correspond to a 60 second recorded event, with a first view provided for a first time point during the event, a second view provided for the next time point during the event, etc.). In some implementations, a unique viewing perspective of the recorded event may be generated by the content instruction set 306 based on a previously recorded viewpoint of the event, and that unique viewing perspective need not correspond to a location from which the event was previously recorded. In some implementations, the viewpoint may be specified by the renderer (e.g., changing based on current renderer HMD poses). In some implementations, the 3D representation can include expiration values for another device to render the content more efficiently (as will be discussed in more detail herein).

The location map 310 illustrates a two-dimensional (2D) top-down view of locations of representations of devices or other representations of objects within a 3D environment. In this example, during an example of recording content for an event, a recording or viewing session instruction set executed on an electronic device (e.g., device 105), or networked through an external server, can generate a location map 310 based on the detected devices (e.g., device 105, 165, 175, etc.). For example, as illustrated in the location map 310, the location of device 105 as indicated by location indicator 305 is {ABCD}, the location of device 165 as indicated by location indicator 365 is {EFGH}, the location of device 175 as indicated by location indicator 375 is {MNOP}, and the location of device 185 as indicated by location indicator 385 is {IJKL}. In some implementations, each device's location may be determined and/or approximated based of another device's location at a particular time (e.g., based on the short-range sensor data, GPS coordinates, WiFi location, SLAM localization techniques, a combination thereof, or the like). In some implementations, each device's location may be determined and/or approximated based on identifying one or more objects within the view of an acquired image(s). For example, if the event was a party, the person who's birthday it is may be used to detect positions of other devices that have accepted to share data from the same event. Additionally or alternatively a static object may used as anchor, such as desk 130. Thus, as new content is being obtained while the user/device is moving throughout the environment, the static object (desk) can be used as anchor when analyzing and combining different subsets of RGB image data during recording of the party (e.g., a 60 second clip of watching the birthday party blow out candles may be recreated by the multiple device's content.

In an exemplary implementation, the physical environment includes a third user (or more) associated with a third device that is to be depicted in the in the view of the 3D environment by the first device (e.g., device 175 for user 170, device 185 for user 180 within physical environment 102). In some implementations, determining position data indicative of the location of another device relative to the first device is based on identifying a mesh network associated with location information for the first device, the second device, and the third device. For example, as illustrated in FIG. 3, a mesh network may be used to continuously update the locations of each device. In particular, location indicator 305 depicts a location for device 105 at Loc: {ABCD}, location indicator 365 depicts a location for device 165 at Loc: {EFGH}, location indicator 385 depicts a location for device 185 at Loc: {IJKL}, and location indicator 375 depicts a location for device 175 at Loc: {MNOP}, for the physical environment 102.

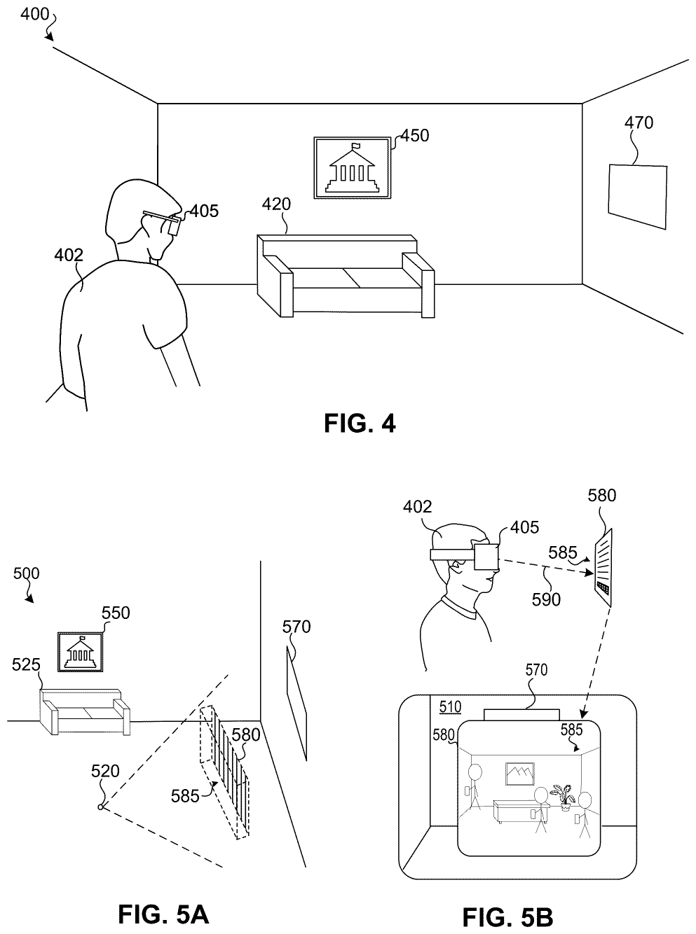

FIG. 4 illustrates exemplary electronic device 405 operating in a physical environment 400. In particular, FIG. 4 illustrates an exemplary electronic device 405 operating in a different physical environment (e.g., physical environment 400) than the physical environment of FIG. 1 (e.g., physical environment 102). In other words, this different environment is where a user (e.g., user 402) may want to view and replay the shared event that was recorded by device 105, 165, 175, and/or 185. Additionally, by wearing an HMD, the user 402 may be able to be fully immersed in the view of the party/event (e.g., can walk around based on the different pose of the device 405, then applicable scene reconstruction may be updated). Alternatively, only a partially immersed view maybe used, such as view through a portal, as illustrated in FIGS. 5A, 5B.

In the example of FIG. 4, the physical environment 400 is a room that includes a couch 420, a wall hanging 450, and a television screen 470. The electronic device 405 may include one or more cameras, microphones, depth sensors, or other sensors that can be used to capture information about and evaluate the physical environment 400 and the objects within it, as well as information about the user 402 of electronic device 105. The information about the physical environment 400 and/or user 402 may be used to provide visual and audio content and/or to identify the current location of the physical environment 400 and/or the location of the user within the physical environment 400.

In some implementations, views of an XR environment may be provided to one or more participants (e.g., user 402 and/or other participants not shown, such as user 110) via electronic devices 405, e.g., a wearable device such as an HMD, and/or a handheld device such as a mobile device, a tablet computing device, a laptop computer, etc. (e.g., device 165). Such an XR environment may include views of a 3D environment that is generated based on camera images and/or depth camera images of the physical environment 400 as well as a representation of user 402 based on camera images and/or depth camera images of the user 402. Such an XR environment may include virtual content that is positioned at 3D locations relative to a 3D coordinate system (e.g., a 3D space) associated with the XR environment, which may correspond to a 3D coordinate system of the physical environment 400.

In some implementations, video (e.g., pass-through video depicting a physical environment) is received from an image sensor of a device (e.g., device 405) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

FIG. 5A illustrates an exemplary 3D environment 500 generated based on the physical environment 400 of FIG. 4 and a portal 580 displaying content 585 within the 3D environment, in accordance with some implementations. The portal 580 may also referred to herein as a projection of a 3D image. The 3D environment 500 includes representations 525, 550, and 570 of the couch 420, wall hanging 450, and television screen 470, respectively, of the physical environment 400. The 3D environment 500 also includes content 585 that is displayed to form a shape of the portal 580. In some implementations, the shape of the portal 580 may be any geometric shape that is able to project content (e.g., a 3D virtual shape such as a half-sphere, aka a “snow globe” view). The content 585 being displayed by portal 580 constitutes the portal (e.g., a projection of an image), as discussed herein.

The electronic device 405 provides views of the physical environment 400 that include depictions of the 3D environment 500 from a viewpoint 520 (e.g., also referred to herein as a viewer position), which in this example is determined based on the position of the electronic device 405 in the physical environment 400 (e.g., a viewpoint of the user 502, also referred to herein as the “viewer's position” or “viewer's viewpoint”). Thus, as the user 402 moves with the electronic device 405 (e.g., an HMD) relative to the physical environment 400, the viewpoint 520 corresponding the position of the electronic device 405 is moved relative to the 3D environment 500. The view of the 3D environment provided by the electronic device changes based on changes to the viewpoint 520 relative to the 3D environment 500. In some implementations, the 3D environment 500 does not include representations of the physical environment 500, for example, including only virtual content corresponding to a virtual reality environment.

FIG. 5B illustrates an exemplary interaction with the content 585 displayed within the portal 580 of FIG. 5A, in accordance with some implementations. For example, FIG. 5 illustrates an exemplary “indirect” interaction involving while gazing along gaze direction 590 to select or interact with content of a user interface (e.g., content 585) within the portal 580. In this example, the user 402 is using device 405 to view and interact with an XR environment that may include a user interface (e.g., content 585 within a portal 580) within a view of the XR environment 510. A direct interaction recognition process may use sensor data and/or UI information to determine, for example, which UI element the user's hand is virtually touching and/or where on that UI element the interaction occurs. Direct interaction may additionally (or alternatively) involve assessing user activity to determine the user's intent, e.g., did the user intend to a straight tap gesture through the UI element or a sliding/scrolling motion along the UI element. Such recognition may utilize information about the UI elements, e.g., regarding the positions, sizing, type of element, types of interactions that are capable on the element, types of interactions that are enabled on the element, which of a set of potential target elements for a user activity accepts which types of interactions, etc.

FIG. 5B further illustrates a view of an XR environment 510, provided via the device 405, of virtual elements within the 3D physical environment of FIG. 5A, in which the user 402 may perform an interaction. In this example, the user 402 makes a hand gesture relative to content presented in view of an XR environment 510 provided by a device (e.g., device 405). The view of the XR environment 510 includes an exemplary user interface (e.g., content 585 within a portal 580) of an application and a depiction 570 of television screen 470 (e.g., a representation of a physical object that may be viewed as pass-through video or may be a direct view of the physical object through a transparent or translucent display). Additionally, the view of the XR environment 510 may include a representation of a hand/arm of the user 402. Providing such a view may involve determining 3D attributes of the physical environment 400 and positioning virtual content, e.g., user interface within the portal 580, in a 3D coordinate system corresponding to that physical environment 400.

In the examples of FIG. 5B, the user interface within the portal 580 include various content items, including a background portion, an application portion, a control element(s), and/or a scroll bar (not shown). The application portion (e.g., content 585) may be displayed with 3D effects in the view provided by device 405. The user interface within the portal 580 (e.g., portal content 585 displayed within the 580) is simplified for purposes of illustration and user interfaces in practice may include any degree of complexity, any number of content items, and/or combinations of 2D and/or 3D content. The user interface of the portal 580 may be provided by operating systems and/or applications of various types including, but not limited to, messaging applications, web browser applications, content viewing applications, content creation and editing applications, or any other applications that can display, present, or otherwise use visual and/or audio content.

In some implementations, the positions and/or orientations of such one or more user interfaces may be determined to facilitate visibility and/or use. The one or more user interfaces may be at fixed positions and orientations within the 3D environment. In such cases, user movements would not affect the position or orientation of the user interfaces within the 3D environment. Additionally, the views of the XR environment 510 may be altered based on a level of immersion. For example, as illustrated in FIG. 5B, the user 402 can view his or her background environment clearly outside of the portal 580, thus would be considered a lower level of immersion. However, the rendered 3D content 585 may be scaled to be more immersive such that a user 402 may be able to walk around in his or her physical environment, but be able to view and interact with the recording of the shared event based on head pose and location in order to view different viewpoints for the rendered event that may not have been captured from an original source viewpoint, but were synthesized (e.g., creating a 3D view from a series of 2D images). The view synthesis can be done using a series of photos that show an object from multiple angles, create a hemispheric plan of the object, and place each image in the appropriate place around the object. A view synthesis function attempts to predict the depth given a series of images that describe different perspectives of an object.

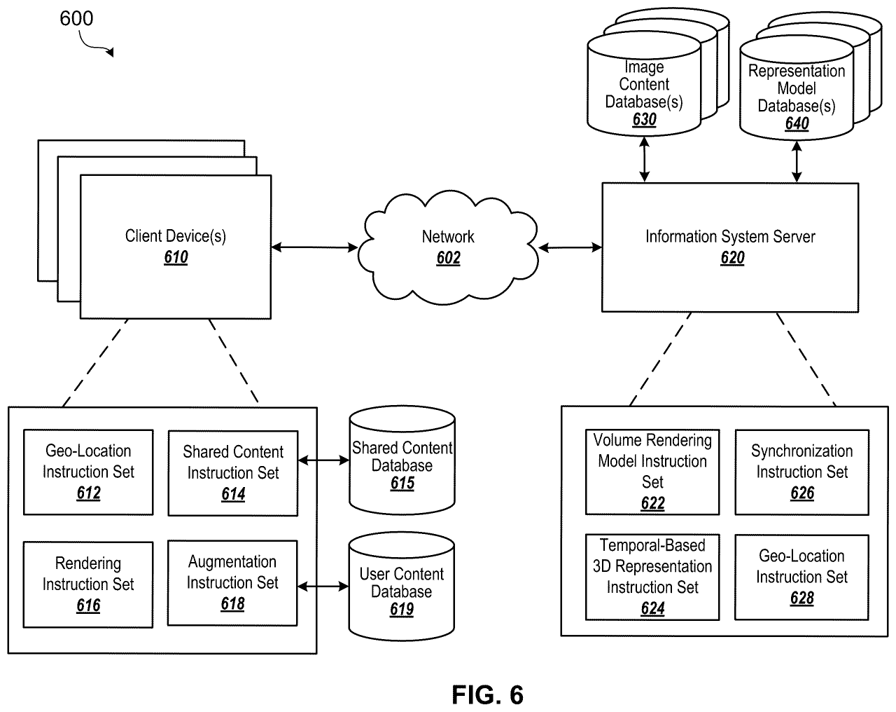

The position of the user interface within the 3D environment may be based on determining a distance of the user interface from the user (e.g., from an initial or current user position). The position and/or distance from the user may be determined based on various criteria including, but not limited to, criteria that accounts for application type, application functionality, content type, content/text size, environment type, environment size, environment complexity, environment lighting, presence of others in the environment, use of the application or content by multiple users, user preferences, user input, and numerous other factors. In the example of FIGS. 1-5, the electronic devices 165, 175, and 185 are illustrated as hand-held devices, and electronic devices and 105 and 405 are illustrated as head-mounted devices (HMDs). However, each of the electronic devices 105, 165, 175, 185, and 405 may be a mobile phone, a tablet, a laptop, so forth. In some implementations, electronic devices 105, 165, 175, 185 may be worn by a user such as device 105 and 405. For example, electronic devices 105, 165, 175, 185, and 405 may be a watch, a HMD, head-worn device (glasses), headphones, an ear mounted device, and so forth. In some implementations, functions of the devices 105, 165, 175, 185, and 405 are accomplished via two or more devices, for example a mobile device and base station or a head mounted device and an ear mounted device. Various capabilities may be distributed amongst multiple device, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 105, 165, 175, 185, and 405 that may communicate with one another via wired or wireless communications. In some implementations, each device communicates with a separate controller or server to manage and coordinate an experience for the user (e.g., an information system/server). Such a controller or server, as further illustrated in FIG. 6, may be located in or may be remote relative to the physical environment 102.

FIG. 6 illustrates an example environment 600 for implementing a process for generating a temporal-based 3D representation of a shared event based on sensor data from two or more devices, in accordance with some implementations. The example environment 600 includes one or more client devices 610 (e.g., electronic devices 105, 165, 175, 185, 405, etc.), and an information system server 620, that communicates over a data communication network 602, e.g., a local area network (LAN), a wide area network (WAN), the Internet, a mobile network, or a combination thereof.

The electronic device(s) 610 (e.g., an electronic device used by a user, such as user device 105 used by user 110) may be a mobile phone, a tablet, a laptop, an HMD, and so forth. In some implementations, each electronic device 610 may be worn by a user. For example, electronic device 610 may be a watch, a head-mounted device (HMD), head-worn device (glasses), headphones, an ear mounted device, and so forth. In some implementations, functions of the device 610 are accomplished via two or more devices, for example a mobile device and base station or a head mounted device and an ear mounted device. Various capabilities may be distributed amongst multiple devices, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 105, 165, 175, 185, and 405 may communicate with one another via wired or wireless communications over network 602. In some implementations, each device communicates with a separate controller or server to manage and coordinate an experience for the user (e.g., an information system server 620 utilizing a communication session instruction set 616). Such a controller or server may be located in or may be remote relative to the physical environment of the device 105 (e.g., physical environment 102).

An example system flow of the example environment 600 includes the client device 610 acquiring light intensity image data (e.g., live camera feed such as RGB from light intensity cameras), depth image data (e.g., RGB-D from a depth camera), motion trajectory data from motion sensor(s) of a physical environment (e.g., the physical environment 102 of FIG. 1) by a shared content instruction set 614 and locally stores the image data from shared events at the shared content database 615. The client device 610 may also include a rendering instruction set 616 that generates 3D representation data (e.g., representation of an event) based on a volume rendering model (e.g., a NeRF model) from the information system server 620.

For positioning information, the client device 610 may also include a geo-location instruction set 612. The geo-location instruction set 612 and the device 610 may include a VIO system to determine equivalent odometry information using sequential camera images (e.g., light intensity image data) and motion data (e.g., acquired from the IMU/motion sensor) to estimate the distance traveled. In some implementations, other sources of physical environment information can be acquired (e.g., camera positioning information such as position and orientation data from position sensors) as opposed to using a VIO system. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the client device 610 includes a geo-location instruction set 612 that is configured with instructions executable by a processor to obtain sensor data (e.g., RGB data, depth data, etc.) and track a location of a moving device (e.g., device 610, device 105, etc.) in a 3D coordinate system using one or more techniques. For example, the geo-location instruction set 612 analyzes RGB images from a light intensity camera with a sparse depth map from a depth camera (e.g., time-of-flight sensor), plane extraction data (e.g., plane estimation parameters), and other sources of physical environment information (e.g., camera positioning information such as VIO data, or a camera's SLAM system, or the like) to generate location data by tracking device location information for 3D reconstruction of a scene (e.g., a 3D model representing one or more objects of the physical environment of FIG. 1).

In an example implementation, the device 610 includes a shared content instruction set 614 that is configured with instructions executable by a processor to obtain the sensor data (e.g., RGB data, depth data, etc.) and location data from the geo-location instruction set 612 and generate 3D representation data using one or more techniques. For example, the shared content instruction set 614 analyzes RGB images from a light intensity camera with a sparse depth map from a depth camera (e.g., time-of-flight sensor, passive or active stereo sensors such as a structured light depth camera, and the like), and other sources of physical environment information (e.g., camera positioning information such as VIO data, or a camera's SLAM system, or the like) to generate 3D representation data. For example, as illustrated in the example view of the environment 200A in FIG. 2A, 3D representation data may include the representation 230 of the desk 130 and a representation 220 of the wall hanging 120.

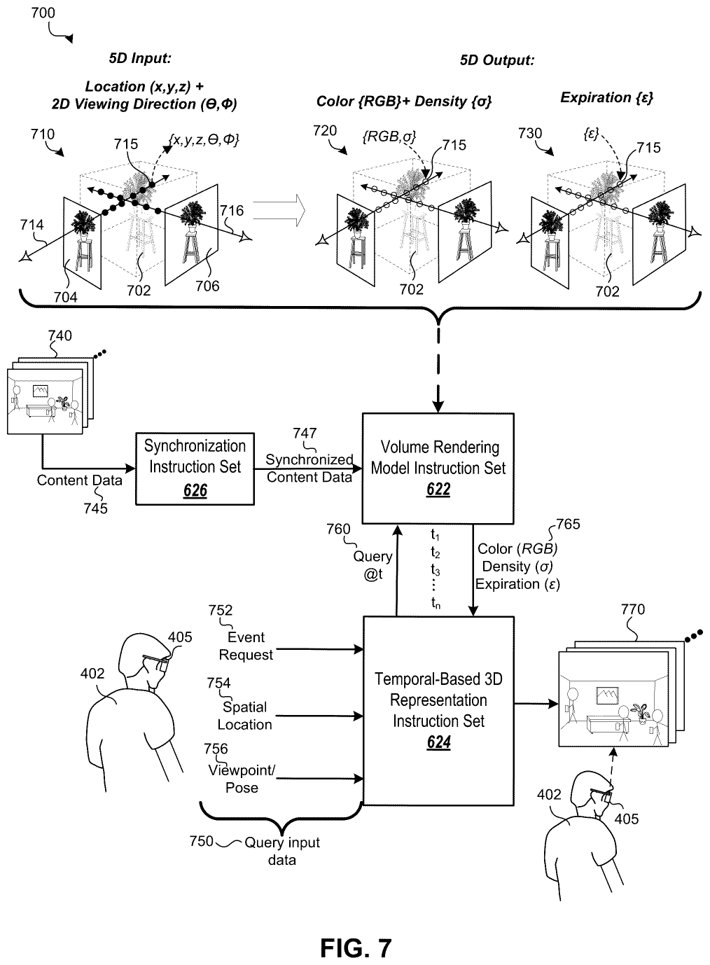

In an example implementation, the device 610 includes a rendering instruction set 616 that is configured with instructions executable by a processor to obtain a volume rendering model from the information system server. For example, in some implementations, the device 610 via rendering instruction set 616 obtains a volume rendering from the information system server 620 via the volume rendering model instruction set 622 (which may store such models in the representation model database(s) 640) and the temporal-based 3D representation instruction set that queries volume rendering model instruction set 622 as further described herein with FIG. 7.

In an example implementation, the device 610 further includes an augmentation instruction set 618 that is configured with instructions executable by a processor to facilitate obtaining client-specific images (e.g., a personal photo library) from a locally stored database (e.g., user content database 619) or from an online media library (e.g., a cloud database) in order to assist in synthesizing data that may be missing from a shared recorded event. In other words, the augmentation instruction set 618 may facilitate access to a client-specific image library where personal pictures are stored to potentially fill in images for a recorded event that may be missing data. For example, personal images may be used to augment the recreated event only for the specific user that has the personal pictures. For instance, if the perceived view of the event is from a position that was not originally captured in the initial recording (e.g., front of friend's head was captured), then if the replayed perspective is from a location that sees the back of the friend's head (which was not originally captured), the client device 610 can leverage the stored personal images of the back of the friend's head (captured at an entirely different time and place) to fill in the content during replay.

The information system server 620 (e.g., a server within the information system 104) is an external server that is configured to facilitate generating a temporal-based 3D representation system based on image data from two or more client devices 610. In some implementations, the information system server 620 determines that a user opted in to the receiving of image data for particular shared event. For example, the information system server 620 can access all of the shared content associated with the event from the image content database(s) 630.

In an example implementation, the information system server 620 includes a volume rendering model instruction set 622 that is configured with instructions executable by a processor to facilitate the exchange of input data (e.g., 5D input data that includes location (x, y, z) and a 2D viewing direction {θ, ϕ}) and output data (e.g., 5D output data that includes color {RGB}, density {σ}, and expiration values {ε}) based on a query from the temporal-based 3D representation instruction set 624, which will be further described herein with reference to FIG. 7. The volume rendering model instruction set 622 may be a NeRF neural network. For example, a NeRF is a fully-connected neural network that can generate novel views of complex 3D scenes, based on a partial set of 2D images. A NeRF is trained to use a rendering loss to reproduce input views of a scene and works by taking input images representing a scene and interpolating between them to render one complete scene. NeRF is a highly effective way to generate images for synthetic data. However, one advantage in the instant disclosure over a typical NeRF model, is that the volume rendering model instruction set 622 may also output an expiration value {ε}, which will be further discussed herein with reference to FIG. 7.

In an example implementation, the information system server 620 also includes a synchronization instruction set 626 that is configured with instructions executable by a processor to synchronize data from multiple devices (e.g., finding timestamps for frames from different devices based on a common clock). For example, the content data (e.g., images, video, etc.) obtained from the multiple client devices 610 is unsynchronized data and needs to be synchronized before generating the volume rendering model by the volume rendering model instruction set 622. The synchronization of the data received from multiple unsynchronized devices may be based on a common clock synchronization such as an Internet Time Service (ITS), the captured image/video content, captured audio, or a combination thereof.

Additionally, or alternatively, in some implementations, synchronization of the data may be based on the recorded audio via one or more techniques. For example, synchronization between two recordings may be based on audio-classification by correlating the audio classes that would need a temporal overlap to determine the synchronization point. Additionally, synchronization between two recordings may be based on audio-fingerprints to represent the recorded audio. Additionally, or alternatively, in some implementations, synchronization of the data may be based on tracking moving objects and identifying inflection points and refining an estimate of synchronization using a consensus based matching heuristic to find moving features that best agree with the pre-computed camera geometries from stationary image features. Additionally, or alternatively, in some implementations, synchronization of the data may be based on detecting space-time interest points in the data and using scale-adapted techniques to select the strongest interest points using a uniform search with uniform sampling algorithm in each video to form a distribution of space-time interest points. This distribution becomes a descriptor of a time feature of the video, and a correlation algorithm can correlate these distributions and estimate temporal difference between videos.

In some implementations, even after synchronization (e.g., finding timestamps for frames from different devices based on a common clock), the actual camera integration times of the different cameras are more than likely not aligned, therefore frames from different devices may be temporally close, but may not capture an identical point in time. Moreover, images from different devices may have gone through different imaging pipelines and therefore, even if each client device 610 observes a common part of a scene, that common part may look very different in the images from the two cameras based on the different camera properties. For example, even two photos taken at the same time and location can exhibit considerable variation, i.e., exposure, color correction, and tone-mapping all may vary depending on the camera and post-processing. Therefore, in an exemplary implementation, the synchronization instruction set 626 and/or the volume rendering model instruction set 622 may be further configured to address these issues related to the temporal aspect of the dynamic reconstruction.

In some implementations, to address the potential misalignment of the camera integration times of the different cameras (e.g., frames from different devices may be temporally close, but may not capture an identical point in time), the synchronization instruction set 626 and/or the volume rendering model instruction set 622 may be configured to use temporal interpolation (with a suitable motion model) to synthesize a camera frame at a desired timestamp based on at least one earlier frame and one later frame.

In some implementations, to address the variation in the camera properties from two or more devices (e.g., different imaging pipelines, filtering techniques, lighting issues, etc.), the synchronization instruction set 626 and/or the volume rendering model instruction set 622 may be configured to remove any filtering properties from RGB photos (e.g., based on metadata embedded with each image). In other words, the synchronization and volume rendering model system described herein may modify the obtained RGB images that include various imaging properties or filters and refine the images them to address the variation in the camera properties from two or more devices because of different imaging pipelines, filtering techniques, lighting issues, etc. For example, since almost these type of image transforms are lossy and not invertible, the system may attempt to use approximations of inverting tone mapping and image filters to make them as comparable as possible between image frames and getting them closer to RAW images. In some implementations, if the system has control of the recording application software and the hardware (e.g., camera), is to either record additional metadata to enable the approximations of inversions to be as accurate as possible, and/or to apply less processing effects to the image frames or videos such that they may not look as good when observed without further processing (e.g. no image filters), but the image frames or video data may retain more raw information so it doesn't need to be reconstructed in a lossy process after the fact.

In an example implementation, the information system server 620 also includes a geo-location instruction set 628 that is configured with instructions executable by a processor to facilitate the received positioning and/or location information received from a plurality of client devices 610 (e.g., user devices 105, 165, 175, 185, 405, etc.). In an example implementation, the information system server 620 further includes a mesh/tokenization instruction set that is configured with instructions executable by a processor to facilitate the received positioning and/or location information received from a plurality of anonymized devices from the geo-location instruction set 628, facilitate tokenization processes for maintaining anonymization between devices, and/or facilitate a mesh network between plurality of devices. For example, a mesh network may be utilized based on the location/position data of multiple devices in a room (e.g., devices 105, 165, 175, 185, 405, etc.), while the identity of each device is kept anonymous (e.g., via anonymization, tokenization, etc.). In an exemplary implementation, the physical environment includes a third user (or more) associated with a third device that is to be depicted in the in the view of the 3D environment by the first device (e.g., device 175 for user 170, device 185 for user 180 within physical environment 102). In some implementations, determining position data indicative of the location of the second device relative to the first device is based on identifying a mesh network associated with location information for the first device, the second device, and the third device. For example, as illustrated in FIG. 3, a mesh network may be used to continuously update the locations of each device and thus obtain the current viewpoints or pose of each device for each captured image. For example, Device A (e.g., device 105) may send a message to the server (e.g., information system 104) saying “I see a device with anonymous token 1234 at location X,” (e.g., device 105 identifies device 165 at location {EFGH}). Device B (e.g., device 165) might later say “I see a device with anonymous token 5678 at location X′.” For example, because there is a rotating token system, anonymous token 5678 refers to the same device as token 1234 (e.g., device 185 identifies device 165 at location {EFGH}). Therefore, when Device C (e.g., device 175) sees a device (e.g., device 165) at location X″, it can send the location X″ to the server where the server will retrieve and return user settings associated with the device (e.g., device 165) that was previously determined to be around location XIX′ at location {EFGH} (which should correspond to location X″), as anonymously determined by tokens sent by Device A and Device B.

FIG. 7 illustrates an example environment 700 for implementing a process for generating a temporal-based 3D representation of a shared event from a volume rendering model based on expiration values, in accordance with some implementations. The example environment 700 may include a viewing device 405, a temporal-based 3D representation instruction set 624, and a volume rendering model instruction set 622 that communicates over a data communication network (e.g., network 602), e.g., a LAN, a WAN, the Internet, a mobile network, or a combination thereof. The temporal-based 3D representation instruction set 624 and the volume rendering model instruction set 622 may each be housed externally (e.g., at information system server 620), or may be executed on the viewing/rendering device (e.g., device 405).

An example system flow of the example environment 700, the synchronization instruction set 626 obtains content data 745 from the plurality of content 740 from two or more different devices (e.g., client devices 610) that obtained sensor data at a particular event. As discussed herein, the synchronization instruction set 626 may address the one or more issues with correlating and synchronizing the content data from two or more devices (e.g., common clock synchronization, integration for an exact time point, and/or different imaging pipelines). For example, the content data (e.g., images, video, etc.) obtained from the multiple client devices 610 is unsynchronized data and needs to be synchronized before generating the volume rendering model by the volume rendering model instruction set 622. The synchronization of the data received from multiple unsynchronized devices may be based on a common clock synchronization such as an Internet Time Service (ITS), the captured image/video content, captured audio, or a combination thereof.

After synchronizing the image data from the two or more devices, the volume rendering model instruction set 622 obtains the synchronized content data 747 from the synchronization instruction set 626 and synthesizes the synchronized content data 747 to generate a sampled set of 3D points (e.g., point 715) by marching camera rays through the scene. After an event has been synthesized (e.g., a shared experience ready for viewing), a rendering device (e.g., device 405) initiates a process to view and interact with (e.g., see from different viewpoints) a shared recorded event via event request 752. For example, the user 402 may have attended the event (e.g., a party as illustrated in FIG. 1) and desires to replay the experience but from different viewpoints than what the user 402 may have recorded during the event. Alternatively, if the user 402 did not attend the event another user may provide the user 402 access to a shared event.

In an exemplary implementation, the views at the rendering device (e.g., device 405) may be generated using the volume rendering model instruction set 622, such as a neural rendering model (e.g., a NeRF model) that is trained using sensor data captured during the event (e.g., image data) from multiple locations/devices (e.g., devices 105, 165, 175, 185, etc.) as illustrated in FIG. 1. For example, for each of a plurality of rendering timepoints (e.g., rendering frames), the rendering device 405 may “query” the model (e.g., query @t 760) by specifying query input data 750 (e.g., a time point and a viewpoint) to the model and receive an output from the model (e.g., rays corresponding to pixels of a view of the event at the time and from the viewpoint). For example, the event request 752 may initiate the rendering of an event at a particular point in time, and the query input data 750 may include a 5D input, e.g., a spatial location 754 (e.g., location coordinates (x,y,z) and a viewpoint/pose 756 (e.g., a 2D viewing direction (θ, ϕ)). In the example for FIG. 7, a representation 702 of an object (e.g., a plant on top of a stool) is used to illustrate the volume rendering process using a NeRF model for generating the 2D images 704, 706, for a plurality of points along a direction/viewpoint of the camera image and illustrating with the 3D coordinate point 715.

In an exemplary implementation, the volume rendering of the volume rendering model instruction set 622 enables the creation of a 2D projection of a 3D discretely sampled dataset as shown in the 5D input illustration 710. As an output, for a given camera position (e.g., spatial location 754 and viewpoint/pose 756) associated with an event request (e.g., a time period), a volume rendering algorithm of the volume rendering model instruction set 622 obtains the RGBσ (Red, Green, Blue, and Density channel) for every voxel in the space through which rays from the camera are casted (e.g., casted rays 714, 716). The RGBσ color is converted to an RGB color and recorded in the corresponding pixel of the 2D image (e.g., 2D images 704, 706). The process is repeated for every pixel until the entire 2D image is rendered. The output of the volume rendering model instruction set 622 would include a 5D output illustration 720 (e.g., RGBσ color) and illustration 730 (e.g., an expiration value (ε)).

In an exemplary implementation, the volume rendering model instruction set 622 additionally determines and returns an “expiration” value (E) as part of the output (e.g., an expiration time for each ray). The renderer (device 405) uses the expiration value (E) to limit its queries to the volume rendering model instruction set 622. For example, if the viewpoint has not changed (e.g., within a threshold) from one time (t₁) to the next time (t₂), the renderer may not need to query the model for certain new values (e.g., rays that have not expired). For those instances that the renderer does not need to query the volume rendering model instruction set 622, there may be a reduction in the number of queries when rendering a dynamic scene that has many static parts from a fixed viewpoint. The renderer (e.g., device 405 via the temporal-based 3D representation instruction set 624) only queries the volume rendering model instruction set 622 at positions where something changed in the scene and avoids repeatedly querying the volume rendering model instruction set 622 about parts of the scene that did not change, which will significantly reduce the number of queries needed, reduce computational complexity, and may enable rendering at higher frame rates, at higher resolutions, or with less power.

In some implementations, a renderer may cache and reuse the returned density and color for that query (or even the color for that pixel accumulated from multiple query results) until the expiration date, and only after the expiration date start querying that same ray again. This way, the renderer (device 405) only queries the volume rendering model instruction set 622 (e.g., a NeRF model with expiration values) at positions where something changed in the scene and it avoids repeatedly querying the volume rendering model instruction set 622 about parts of the scene that did not change. Thus, after inputting a query @t1 (e.g., query input @t 760), the volume rendering model instruction set 622 returns the output data 765 (e.g., an emitted color (RGB), volume density (σ), and an expiration value (c). Then the output data 765 may be used by the temporal-based 3D representation instruction set 62 to generate a temporal-based 3D representation 770 (e.g., a rendering of the party as illustrated in FIG. 1) that the user 402 can view different viewpoints in the dynamic scene that were synthesized from different content from different viewpoints.

In some implementations, the expiration values determined by a volume rendering model instruction set 622 may be based on dissimilarity thresholds regarding colors/densities-transparency differences, e.g., the standard deviation of values, or the difference between the min and max values. To determine whether a given ray results in sufficiently similar density and color over a given series of timestamps, thresholds on statistics of those densities and colors may be used, e.g., the standard deviation of values, or the difference between the minimum and the maximum value. If such statistics exceed defined thresholds, then this may be considered a scene change, and the expiration date of previous rays is set to this time of scene change.

In some implementations, thresholds on ray dissimilarity metrics can be used to determine whether a first ray and a second ray are similar enough such that the cached result for the first ray can be used as a substitute for the second ray, i.e., such that there is no need to query the second ray. Ray dissimilarity metrics may include the angle between two rays, the Euclidean distance between the origins of two rays, the Euclidean distance from the origin of the first ray to the straight line formed by the second ray. For example, two rays can be considered similar enough if their origins differ by less than one cm and their directions differ by less than one degree.

Additionally, or alternatively, in some implementations, expiration values determined by a volume rendering model may be based on ray differences, e.g., angle between two rays, ray origin differences, etc. Additionally, or alternatively, in some implementations, expiration values determined by a volume rendering model may be based on a per-frame expiration budget (similar number of rays expiring at the same time), and/or a prioritization based on visible scene changes.

In some implementations, for image content that was not captured by the multiple devices (e.g., a back side of user in the video), then the information system server may be able to utilize content that may have been designated as “shared content” if given permission by the user of the shared content (e.g., locally save image data on their own device). Thus, if a renderer changes to a viewpoint that may not have been synthesized yet due to lack of information (e.g., a back of a person's head), the system may be able to query from another source (e.g., locally saved, or a personal cloud server). In another example, the device may locally augment the image content without requiring the device to share the personal content to the cloud.

In some implementations, the shared event recording and rendering processes described herein may be utilized for live streaming, sampling rate control, and some other possible implementation details. For example, for live streaming, the shared event recording and rendering processes requires knowledge of the future (e.g., how long does this part of the scene remain unchanged), so that the image data is well-suited for offline batch processing of recorded content. The shared event recording and rendering processes can also be used for live streaming of events using NeRFs plus expiration values (e.g., one NeRF per frame, or one NeRF per second that encodes 90 frames) if a small latency is tolerated for the final rendering. For example, if the live streaming content is delayed by one second, shared event recording and rendering algorithm can tolerate is able to look into the future for one second, then the expiration value can be anything less or equal to one second, and it will be one second for static parts of the scene. Having to sample those rays only once per second based on a query instead of 90 times per second presents a substantial efficiency improvement over other NeRF protocols.

In some implementations, for sampling rate control, the shared event recording and rendering processes may utilize the ray expiration dates, and determine that such expiration values such that there is a number of all rays expiring at any given timestamp is capped to a certain value (e.g., per-frame expiration budget). Any rays that should also expire at the same timestamp but would exceed the per-frame expiration budget, may be assigned a slightly later expiration date, e.g., one timestamp later. Sorting dynamic scene changes by their difference may be used to prioritize setting the expiration date of strong scene changes correctly, while the expiration date of less severe scene changes can be slightly delayed. In some implementations, the determination of expiration dates attempts to achieve a similar number of expiring rays at every given frame therefore resulting in a more constant compute load over time. This can again be achieved by prioritizing the temporal accuracy of the expiration date of highly visible scene changes while deprioritizing less visible scene changes which can be assigned a slightly later expiration date resulting in them being updated by the renderer slightly later then they actually occurred.

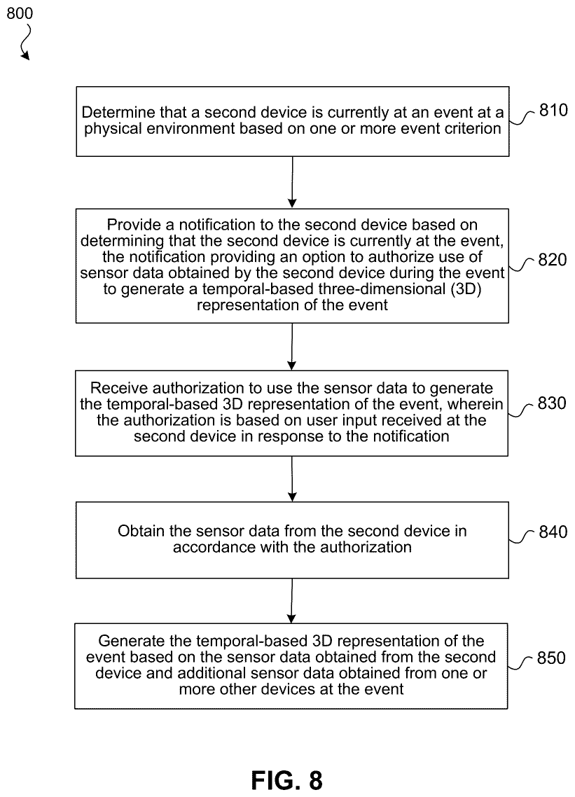

FIG. 8 is a flowchart illustrating a method 800 for generating a temporal-based 3D representation of a shared event based on sensor data from two or more devices, in accordance with some implementations. In some implementations, a device, such as electronic device 105, or electronic devices 165, 175, 185, 405, and the like, or a combination of any/each, performs method 800. In some implementations, method 800 is performed on a mobile device, desktop, laptop, HMD, ear-mounted device or server device (e.g., information system server 620), or a combination thereof. The method 800 is performed by processing logic, including hardware, firmware, software, or a combination thereof. In some implementations, the method 800 is performed on a processor executing code stored in a non-transitory computer-readable medium (e.g., a memory).

At block 810, the method 800, at a first device that includes one or more processors, determines that a second device is currently at (e.g., proximate) an event at a physical environment based on one or more event criterion. The first device may be server or may be one of the participants devices. The one or more event criterion may be based on a physical location, timeline constraints, geofence, metadata (e.g., a tagged event or a shared event).

At block 820, the method 800 provides a notification to the second device based on determining that the second device is currently at the event, the notification providing an option to authorize use of sensor data obtained by the second device during the event to generate a temporal-based 3D representation of the event. For example, as illustrated in FIG. 2B, a transcription bubble 290 is provided for requesting permission from user 160 to consent to authorizing the participation of sharing recorded content for a particular event (e.g., a party, a concert, etc.).

At block 830, the method 800 receives authorization to use the sensor data to generate the temporal-based 3D representation of the event, wherein the authorization is based on user input received at the second device in response to the notification. For example, as illustrated in FIG. 2B, the user 160 may select “Yes” in the transcription bubble 290, where selecting “Yes” may be based on a gaze and hand movement, a direct interaction with the transcription bubble 290 (e.g., the user reaching out and trying interact/touch the user interface in the 3D space), or may be based on a verbal command that user 160 says “Yes I approve consent,” or something similar.

At block 840, the method 800 obtains the sensor data (e.g., images, video, depth images, etc.) from the second device in accordance with the authorization. At block 850, the method 800 generates the temporal-based 3D representation of the event based on the sensor data obtained from the second device and additional sensor data obtained from one or more other devices at the event. For example, the system may require at least a third source in order to generate the temporal-based 3D representation of the event (e.g., more viewpoints of the multi-user event).

In some implementations, the additional sensor data is obtained from the one or more other devices at the event based on receiving additional authorization from the one or more other devices at the event to use the additional sensor data to generate the temporal-based 3D representation of the event.

In some implementations, the method 800 further includes updating a portion of the temporal-based 3D representation of the event by obtaining user-based image content from a user database and augmenting the portion of the temporal-based 3D representation of the event based on the user-based image content. For example, if the perceived view of the event is from a position that was not originally captured in the initial recording (e.g., front of friend's head was captured), then if the replayed perspective is from a location that sees the back of the friend's head (which was not originally captured), the device (e.g., client device 610 utilizing the augmentation instruction set 618 and user content database 619) can leverage the stored personal images of the back of the friend's head (captured at an entirely different time and place) to fill in the content during replay.

In some implementations, the temporal-based 3D representation is a neural rendering model. In some implementations, the neural rendering model is neural radiance field (NeRF) model. In some implementations, the NeRF model is configured to receive input corresponding to a 3D viewpoint and a timepoint during the event. In some implementations, the NeRF model is configured to output a plurality of ray values corresponding to a view of the event from the 3D viewpoint at the timepoint during the event.

In some implementations, the NeRF model (e.g., the temporal-based 3D representation) is configured to output an expiration corresponding to one or more of the ray values. In some implementations, the expiration is determined based on a dissimilarity threshold corresponding to ray color or ray density. In some implementations, the expiration is determined based on a dissimilarity threshold corresponding to ray position or orientation differences. In some implementations, the expiration is determined based on a per-timepoint expiration budget. In some implementations, the expiration is determined based on a prioritization determined based on determining visible scene changes.

In some implementations, access to use the temporal-based 3D representation of the event is based on the authorization. In some implementations, only users who contributed to the temporal-based 3D representation (e.g., by providing sensor data) are granted access to use the temporal-based 3D representation of the event is based on the authorization.

In some implementations, an information system/server determines that the second user provides user consent to the receiving a user preference setting associated with the second user at the first device based on receiving, at the first device via the information system, an affirmative response from the second user (or from a device associated with the second user) to a consent request. For example, as illustrated in FIG. 2B, the user 160 is provided a notification bubble 290 that the user 160 needs to affirmatively select whether or not to allow consent to participate in shared event (e.g., via an input device such as a mouse, via selecting an interactable element on the display of the device 165, via an audio cue such as saying “yes”, or the like).

In some implementations, generating the temporal-based 3D representation of the event based on the sensor data obtained from the second device and the additional sensor data obtained from the one or more other devices at the event includes determining synchronized data based on the sensor data obtained from the second device and the additional sensor data obtained from the one or more other devices based on one or more synchronization algorithms, and generating the temporal-based 3D representation of the event based on the determined synchronized data. In some implementations, the one or more synchronization algorithms are based on a common clock synchronization associated with the second device and the one or more other devices, image content obtained from the second device corresponding to additional image content obtained from the one or more other devices, audio content obtained from the second device corresponding to additional audio content obtained from the one or more other devices, or a combination thereof. For example, as illustrated in FIGS. 7, the synchronization instruction set 626 obtains content data 745 from multiple unsynchronized client devices 610, and synchronizes the data (synchronized content data 757), which may be based on an ITS correlated with each device, image/video content obtained from each device (e.g., associated with identifying objects within the captured images/video), captured audio (e.g., associated with identifying particular audio segments within the captured video), or a combination thereof).

In some implementations, generating the temporal-based 3D representation of the event based on the sensor data obtained from the second device and the additional sensor data obtained from the one or more other devices at the event includes determining refined image data (e.g., raw RGB data) based on the sensor data obtained from the second device and the additional sensor data obtained from the one or more other devices based on one or more transformation algorithms, and generating the temporal-based 3D representation of the event based on the determined refined image data. For example, to address the variation in the camera properties from two or more devices because of different imaging pipelines, filtering techniques, lighting issues, etc., the techniques described herein may adjust one or more frames of images or video content from the multiple devices so that each frame comprises the same or very similar image content, such as raw RGB data. For example, obtained image data may include filters and/or tone mapping attributes. The refined image data images may be attributed with intensities transformed to a common nominal space (or domain). The objective of refining the image data is to update the same pixel value in two images in order to correspond to the same amount of incident radiance. This transformation may be using a linear space, using gamma correction/encoding, or the like, as long as it is consistent between multiple images for the synchronization. As discussed herein with reference to FIGS. 6 and 7, the synchronization instruction set 626 and/or the volume rendering model instruction set 622 may determine refined image data (e.g., raw RGB data) before the volume rendering model instruction set 622 generates temporal-based 3D representation.

In some implementations, the information system is a server external to the first device (e.g., information system server 620). Alternatively, in some implementations, the information system is located at the first device. For example, a device (e.g., device 105) may be configured with the volume rendering model instruction set 622 and a temporal-based 3D representation instruction set for the rendering instruction set 616 with access to the representation model databases(s) 640.

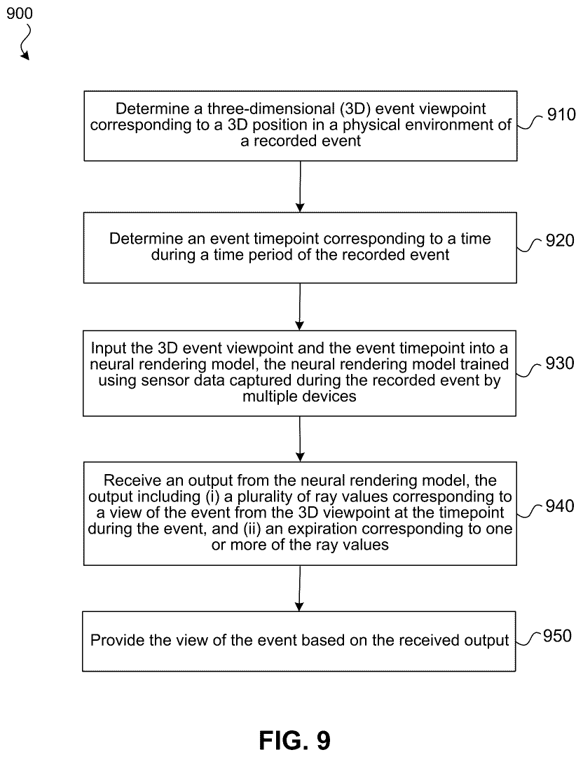

FIG. 9 is a flowchart illustrating a method 900 for providing a view of a recorded event based on an output from a neural rendering model, in accordance with some implementations. In some implementations, a device, such as electronic device 105, or electronic devices 165, 175, 185, 405, and the like, or a combination of any/each, performs method 900. In some implementations, method 900 is performed on a mobile device, desktop, laptop, HMD, ear-mounted device or server device (e.g., information system server 620), or a combination thereof. The method 900 is performed by processing logic, including hardware, firmware, software, or a combination thereof. In some implementations, the method 800 is performed on a processor executing code stored in a non-transitory computer-readable medium (e.g., a memory).

The method 900 is performed at an electronic device having a processor, and each block described herein for method 900 (e.g., blocks 910-950) is processed for each of a plurality of rendering timepoints (e.g., rendering frames). In an exemplary implementation, method 900 renders views corresponding to multiple times during a time period of a recorded event (e.g., 60 seconds worth of views are provided that correspond to a 60 second recorded event, with a first view provided for a first time point during the event, a second view provided for the next time point during the event, etc.). Each of the views of the recorded event may be generated based on a viewpoint within the scene of the recorded event and that viewpoint need not correspond to a location in the scene from which the event was recorded. Rather, the viewpoint may be specified by the renderer (e.g., changing based on current renderer HMD poses). The views may be generated using a neural rendering model (e.g., NeRF model) that is trained using sensor data captured during the event (e.g., image data) from multiple locations/devices. For example, for each in time, the rendering device may “query” the model by specifying input (i.e., a time point and a viewpoint) to the model and receive output from the model (e.g., rays corresponding to pixels of a view of the event at the time and from the viewpoint).

In an exemplary implementation, method 900 focuses on a volume rendering model returning an “expiration” as additional output data (e.g., an expiration time for each ray). The renderer may use this information to limit its queries to the volume rendering model. For example, if the viewpoint has not changed (within a threshold) from one time to the next time, the renderer need not query the model for certain new values (e.g., rays that have not expired). This may reduce the number of queries when rendering a dynamic scene that has many static parts, from a fixed viewpoint. The renderer only queries the volume rendering model at positions where something changed in the scene and then avoids repeatedly querying the volume rendering model about parts of the scene that did not change, which will significantly reduce the number of queries needed, reduce computational complexity, and may enable rendering at higher frame rates, at higher resolutions, or with less power. Expiration values may be based on dissimilarity thresholds re (a) colors/densities-transparency differences, e.g., the standard deviation of values, or the difference between the min and max values and/or (b) ray differences, e.g., angle between two rays, ray origin differences, etc. Expiration values may be based on (c) a per-frame expiration budget (similar number of rays expiring at the same time) and/or (d) prioritization based on visible scene changes.

At block 910, the method 900 determines a 3D event viewpoint corresponding to a 3D position in a physical environment of a recorded event. For example, as illustrated in FIG. 7, a neural rendering model may include continuous scene construction that obtains as an input a 5D vector-valued function with the following characteristics for the input: a 3D location x=(x; y; z) and a 2D viewing direction (θ; ϕ). In some implementations, the event viewpoint may be specified by the renderer; the viewpoint may be based on rendering device pose and thus may change for different rendering times based on current rendering device position and/or orientation (e.g., current HMD pose)

At block 920, the method 900 determines an event timepoint corresponding to a time during a time period of the recorded event. For example, the first rendering timepoint may use the first event timepoint, the second rendering timepoint may use the second event timepoint, etc.

At block 930, the method 900 inputs the 3D event viewpoint and the event timepoint into a neural rendering model, the neural rendering model trained using sensor data captured during the recorded event by multiple devices (e.g., multiple mobile devices/phones, multiple HMDs, etc.).

At block 940, the method 900 receives an output from the neural rendering model, the output including (i) a plurality of ray values corresponding to a view of the recorded event from the 3D viewpoint at the timepoint during the recorded event, and (ii) an expiration corresponding to one or more of the ray values.

In some implementations, the expiration is determined based on a dissimilarity threshold corresponding to ray color. Additionally, or alternatively, in some implementations, the expiration is determined based on a dissimilarity threshold corresponding to ray density or transparency. Additionally, or alternatively, in some implementations, the expiration determined based on a dissimilarity threshold corresponding to ray position or orientation differences. Additionally, or alternatively, in some implementations, the expiration is determined based on a per-timepoint expiration budget. Additionally, or alternatively, in some implementations, the expiration is determined based on a prioritization determined based on determining visible scene changes. Thus, expiration values may be based on dissimilarity thresholds regarding colors/densities-transparency differences, e.g., the standard deviation of values, or the difference between the min and max values. Additionally, or alternatively, in some implementations, the expiration values may be based on ray differences, e.g., an angle between two rays, ray origin differences, and the like. Additionally, or alternatively, in some implementations, the expiration values may be based on a per-frame expiration budget (e.g., similar number of rays expiring at the same time), and there may be a prioritization of updating rays based on visible scene changes (e.g., a viewer turns his or her head for a different viewing perspective).

At block 950, the method 900 provides the view of the recorded event based on the received output. For example, the rendering system may provide a view for each timepoint. In some implementations, wherein at least one view for the rendering timepoint reuses rays from a prior view based on the expiration of the rays from the prior view.

In some implementations, the method 900 further includes inputting ray data into the neural rendering model, wherein the ray data identifies a first subset of less than all of the rays in the view that the output is to include, or a second subset of less than all of the rays in the view that the output is to exclude. In some implementations, the first subset or second subset is determined based on expiration data corresponding to expiration of one or more rays output by the neural rendering model for a previous rendering timepoint.

In some implementations, the privacy and/or audio notification settings are automatically set based on a determined context of the physical environment. For example, in a quiet setting, such as a library, the font may be minimized or less distracting. Or, in a loud setting, such as at a music concert, the font of the audio transcription may be bigger and easier to notice that someone is speaking to the listener. The privacy and/or audio notification settings can be adjusted at the speaker device and/or the listener device either automatically or adjusted by each user (e.g., the speaker of the listener).

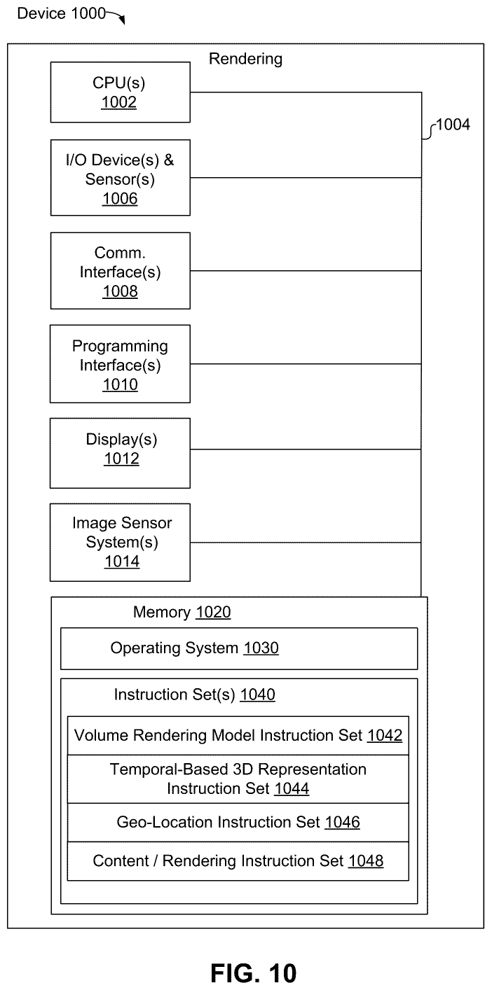

FIG. 10 is a block diagram of electronic device 1000. Device 1000 illustrates an exemplary device configuration for an electronic device, such as device 105, 165, 175, 185, 405, etc. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1010, one or more display(s) 1012 or other output devices, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more device(s) 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 includes a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of an electrical charge. In some implementations, the instruction set(s) 1040 are software that is executable by the one or more processing units 1002 to carry out one or more of the techniques described herein.

The instruction set(s) 1040 includes a volume rendering model instruction set 1042, a temporal-based 3D representation instruction set 1044, a geo-location instruction set 1046, and a content/rendering instruction set 1048. The volume rendering model instruction set 1042 may be configured to, upon execution, determine a volume rendering model as described herein. The temporal-based 3D representation instruction set 1044 may be configured to, upon execution, determine a temporal-based 3D representation as described herein. The geo-location instruction set 1046 may be configured to, upon execution, determine a geo-location of a device as described herein. The content/rendering instruction set 1048 may be configured to, upon execution, determine content and/or rendering instructions for a device as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, the FIG. is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

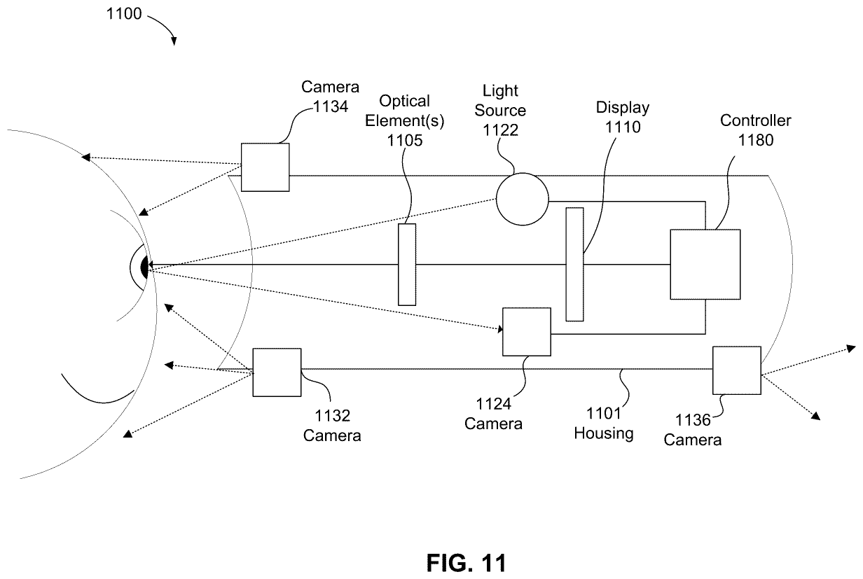

FIG. 11 illustrates a block diagram of an exemplary head-mounted device 1100 in accordance with some implementations. The head-mounted device 1100 includes a housing 1101 (or enclosure) that houses various components of the head-mounted device 1100. The housing 1101 includes (or is coupled to) an eye pad (not shown) disposed at a proximal (to the user 110) end of the housing 1101. In various implementations, the eye pad is a plastic or rubber piece that comfortably and snugly keeps the head-mounted device 1100 in the proper position on the face of the user 110 (e.g., surrounding the eye of the user 110).

The housing 1101 houses a display 1110 that displays an image, emitting light towards or onto the eye of a user 110. In various implementations, the display 1110 emits the light through an eyepiece having one or more optical elements 1105 that refracts the light emitted by the display 1110, making the display appear to the user 110 to be at a virtual distance farther than the actual distance from the eye to the display 1110. For example, optical element(s) 1105 may include one or more lenses, a waveguide, other diffraction optical elements (DOE), and the like. For the user 110 to be able to focus on the display 1110, in various implementations, the virtual distance is at least greater than a minimum focal distance of the eye (e.g., 7 cm). Further, in order to provide a better user experience, in various implementations, the virtual distance is greater than 1 meter.

The housing 1101 also houses a tracking system including one or more light sources 1122, camera 1124, camera 1132, camera 1134, camera 1136, and a controller 1180. The one or more light sources 1122 emit light onto the eye of the user 110 that reflects as a light pattern (e.g., a circle of glints) that may be detected by the camera 1124. Based on the light pattern, the controller 1180 may determine an eye tracking characteristic of the user 110. For example, the controller 1180 may determine a gaze direction and/or a blinking state (eyes open or eyes closed) of the user 110. As another example, the controller 1180 may determine a pupil center, a pupil size, or a point of regard. Thus, in various implementations, the light is emitted by the one or more light sources 1122, reflects off the eye of the user 110, and is detected by the camera 1124. In various implementations, the light from the eye of the user 110 is reflected off a hot mirror or passed through an eyepiece before reaching the camera 1124.

The display 1110 emits light in a first wavelength range and the one or more light sources 1122 emit light in a second wavelength range. Similarly, the camera 1124 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 110 selects an option on the display 1110 by looking at it), provide foveated rendering (e.g., present a higher resolution in an area of the display 1110 the user 110 is looking at and a lower resolution elsewhere on the display 1110), or correct distortions (e.g., for images to be provided on the display 1110).

In various implementations, the one or more light sources 1122 emit light towards the eye of the user 110 which reflects in the form of a plurality of glints.

In various implementations, the camera 1124 is a frame/shutter-based camera that, at a particular point in time or multiple points in time at a frame rate, generates an image of the eye of the user 110. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1124 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1132, camera 1134, and camera 1136 are frame/shutter-based cameras that, at a particular point in time or multiple points in time at a frame rate, may generate an image of the face of the user 110 or capture an external physical environment. For example, camera 1132 captures images of the user's face below the eyes, camera 1134 captures images of the user's face above the eyes, and camera 1136 captures the external environment of the user (e.g., environment 100 of FIG. 1). The images captured by camera 1132, camera 1134, and camera 1136 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a first device comprising one or more processors:
determining that a second device is currently at an event at a physical environment based on one or more event criterion;
providing a notification to the second device based on determining that the second device is currently at the event, the notification providing an option to authorize use of sensor data obtained by the second device during the event to generate a temporal-based three-dimensional (3D) representation of the event;
receiving authorization to use the sensor data to generate the temporal-based 3D representation of the event, wherein the authorization is based on user input received at the second device in response to the notification;
obtaining the sensor data from the second device in accordance with the authorization; and
generating the temporal-based 3D representation of the event based on the sensor data obtained from the second device and additional sensor data obtained from one or more other devices at the event.

2. The method of claim 1, wherein access to use the temporal-based 3D representation of the event is based on the authorization.

3. The method of claim 1, wherein users who contributed to the temporal-based 3D representation are provided access to use the temporal-based 3D representation of the event is based on the authorization.

4. The method of claim 1, wherein the additional sensor data is obtained from the one or more other devices at the event based on receiving additional authorization from the one or more other devices at the event to use the additional sensor data to generate the temporal-based 3D representation of the event.

5. The method of claim 1, wherein the temporal-based 3D representation is a neural rendering model.

6. The method of claim 5, wherein the neural rendering model is neural radiance field (NeRF) model.

7. The method of claim 5, wherein the NeRF model is configured to receive input corresponding to a 3D viewpoint and a timepoint during the event.

8. The method of claim 6, wherein the NeRF model is configured to output a plurality of ray values corresponding to a view of the event from the 3D viewpoint at the timepoint during the event.

9. The method of claim 8, wherein the NeRF model is configured to output an expiration corresponding to one or more of the ray values.

10. The method of claim 9, wherein the expiration is determined based on a dissimilarity threshold corresponding to ray color or ray density.

11. The method of claim 9, wherein the expiration is determined based on a dissimilarity threshold corresponding to ray position or orientation differences.

12. The method of claim 9, wherein the expiration is determined based on a per-timepoint expiration budget.

13. The method of claim 9, wherein the expiration is determined based on a prioritization determined based on determining visible scene changes.

14. The method of claim 1, further comprising updating a portion of the temporal-based 3D representation of the event by:
obtaining user-based image content from a user database; and
augmenting the portion of the temporal-based 3D representation of the event based on the user-based image content.

15. The method of claim 1, generating the temporal-based 3D representation of the event based on the sensor data obtained from the second device and the additional sensor data obtained from the one or more other devices at the event comprises:
determining synchronized data based on the sensor data obtained from the second device and the additional sensor data obtained from the one or more other devices based on one or more synchronization algorithms; and
generating the temporal-based 3D representation of the event based on the determined synchronized data.

16. The method of claim 15, wherein the one or more synchronization algorithms are based on:
a common clock synchronization associated with the second device and the one or more other devices;
image content obtained from the second device corresponding to additional image content obtained from the one or more other devices;
audio content obtained from the second device corresponding to additional audio content obtained from the one or more other devices; or
a combination thereof.

17. The method of claim 1, generating the temporal-based 3D representation of the event based on the sensor data obtained from the second device and the additional sensor data obtained from the one or more other devices at the event comprises:
determining refined image data based on the sensor data obtained from the second device and the additional sensor data obtained from the one or more other devices based on one or more transformation algorithms; and
generating the temporal-based 3D representation of the event based on the determined refined image data.

18. A first device comprising:
one or more sensors;
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
determining that a second device is currently at an event at a physical environment based on one or more event criterion;
providing a notification to the second device based on determining that the second device is currently at the event, the notification providing an option to authorize use of sensor data obtained by the second device during the event to generate a temporal-based three-dimensional (3D) representation of the event;
receiving authorization to use the sensor data to generate the temporal-based 3D representation of the event, wherein the authorization is based on user input received at the second device in response to the notification;
obtaining the sensor data from the second device in accordance with the authorization; and
generating the temporal-based 3D representation of the event based on the sensor data obtained from the second device and additional sensor data obtained from one or more other devices at the event.

19. The device of claim 18, wherein access to use the temporal-based 3D representation of the event is based on the authorization.

20. A non-transitory computer-readable storage medium, storing program instructions executable on a device to perform operations comprising:
determining that a second device is currently at an event at a physical environment based on one or more event criterion;
providing a notification to the second device based on determining that the second device is currently at the event, the notification providing an option to authorize use of sensor data obtained by the second device during the event to generate a temporal-based three-dimensional (3D) representation of the event;
receiving authorization to use the sensor data to generate the temporal-based 3D representation of the event, wherein the authorization is based on user input received at the second device in response to the notification;
obtaining the sensor data from the second device in accordance with the authorization; and
generating the temporal-based 3D representation of the event based on the sensor data obtained from the second device and additional sensor data obtained from one or more other devices at the event.
